(19) United States
(12) Patent Application Publication
(10) Pub. No.: US 2018/0202224 A1
(43) Pub. Date: Jul. 19, 2018

(54) BATTERY OPERATED ROLLER SHADE

(71) Applicant: Crestron Electronics, Inc., Rockleigh, NJ (US)

(72) Inventor: Russikesh Kumar, Ridgewood, NJ (US)

(21) Appl. No.: 15/864,523

(22) Filed: Jan. 8, 2018

Related U.S. Application Data
(60) Provisional application No. 62/446,915, filed on Jan. 17, 2017.

(51) Int. Cl. E06B 9/44; E06B 9/72; H02S 40/38; H02S 99/00; H02S 40/32; H02J 7/35; H02J 7/00

(52) U.S. Cl. CPC E06B 9/44; E06B 9/72; H02S 40/38; E06B 2009/2476; H02S 40/32; H02J 7/35; H02J 7/0054; H02S 99/00

(57) ABSTRACT

A battery powered roller shade, comprising: a shade made of suitable shade fabric or other material; a roller tube, around which can be rolled the shade, the roller tube configured to contain a motor housing, drive wheel, and user interface switches, the motor housing including a motor configured to drive the tube to wind the shade onto the roller tube, and to unwind the shade off of the roller tube; a hembar located at a lowermost position of the shade and configured to maintain tautness in the shade, the hembar configured to house a primary power source that powers the motor; and at least two electrical conductors interwoven in the shade to provide current to the motor by the primary power source.

### BACKGROUND OF THE INVENTION

### Technical Field

The embodiments described herein relate generally to roller shades, and more specifically to systems, methods, and modes for installing and operating a battery operated roller shade with the battery stored in the hembar.

### Background Art

Automated roller shades typically require power to be provided to the shade to energize the motor and associated electronics (radio, control circuitry, encoders, among other devices). Running wire(s) to the window can be difficult especially in retrofit situations.

Battery powered roller shades with radio transceivers for communication provide means to easily install and control a roller shade without running new wires. These shades typically house the batteries in the tube or soffit area out of site from the end user. This, however, makes battery replacement a cumbersome and difficult exercise.

Accordingly, a need has arisen for systems, methods, and modes for installing and operating a battery operated roller shade with the battery stored in the hembar.

### SUMMARY

It is an object of the embodiments to substantially solve at least the problems and/or disadvantages discussed above, and to provide at least one or more of the advantages described below.

It is therefore a general aspect of the embodiments to provide systems, methods, and modes for installing and operating a battery operated roller shade with the battery stored in the hembar that will obviate or minimize problems of the type previously described.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Further features and advantages of the aspects of the embodiments, as well as the structure and operation of the various embodiments, are described in detail below with reference to the accompanying drawings. It is noted that the aspects of the embodiments are not limited to the specific embodiments described herein. Such embodiments are presented herein for illustrative purposes only. Additional embodiments will be apparent to persons skilled in the relevant art(s) based on the teachings contained herein.

According to a first aspect of the embodiments, a battery powered roller shade is provided, comprising: a shade made of suitable shade fabric or other material; a roller tube, around which can be rolled the shade, the roller tube configured to contain a motor housing, drive wheel, and user interface switches, the motor housing including a motor configured to drive the tube to wind the shade onto the roller tube, and to unwind the shade off of the roller tube; a hembar located at a lowermost position of the shade and configured to maintain tautness in the shade, the hembar configured to house a primary power source that powers the motor; and at least two electrical conductors interwoven in the shade to provide current to the motor by the primary power source.

According to the first aspect of the embodiments, the battery powered roller shade further comprises a secondary power source located in the motor housing, the secondary power source configured to provide peak power when needed by the motor to wind or unwind the shade.

According to the first aspect of the embodiments, the battery powered roller shade further comprises a recharging apparatus configured to provide recharging current.

According to the first aspect of the embodiments, the primary power source and the secondary power source comprise one or more rechargeable batteries each, and wherein the recharging apparatus provides recharging current to the primary power source, and the primary power source provides recharging current to the secondary power source.

According to the first aspect of the embodiments, the recharging apparatus comprises a solar powered recharging apparatus configured to be incorporated into the shade material.

According to the first aspect of the embodiments, the recharging apparatus comprises one or more of a solar cell, charging jack, and inductive loop configured to receive electrical alternating voltage and current provided by the building within which the roller shade is located, and convert the alternating voltage and current to a direct voltage and current that can be used to recharge either or both of the primary and secondary power sources.

According to the first aspect of the embodiments, the battery powered roller shade further comprises a low power consuming transceiver configured to receive remotely transmitted commands for operating the shade, and to provide the commands to the motor, and wherein the transceiver is further configured to transmit one or more of roller shade position information, and other status information.

According to the first aspect of the embodiments, the low power consuming transceiver is configured to be housed in the roller tube.

According to the first aspect of the embodiments, the low power consuming transceiver configured to be housed in the hembar.

According to the first aspect of the embodiments, the battery powered roller shade further comprises an antenna for the low power consuming transceiver configured to be located in the roller tube.

According to the first aspect of the embodiments, the battery powered roller shade further comprises an antenna for the low power consuming transceiver configured to be located in the hembar.

According to the first aspect of the embodiments, the battery powered roller shade further comprises a high power consuming transceiver configured to receive remotely transmitted commands for operating the shade, and to provide the commands to the motor, and wherein the transceiver is further configured to transmit one or more of roller shade position information and other status information.

According to the first aspect of the embodiments, the high power consuming transceiver is configured to be housed in the roller tube.

According to the first aspect of the embodiments, the high power consuming transceiver configured to be housed in the hembar.

According to the first aspect of the embodiments, the battery powered roller shade further comprises an antenna for the high power consuming transceiver configured to be located in the roller tube.

According to the first aspect of the embodiments, the battery powered roller shade further comprises an antenna for the high power consuming transceiver configured to be located in the hembar.

According to the first aspect of the embodiments, the battery powered roller shade further comprises a user interface apparatus configured to receive one or more user commands through operation of at least two pull cords operable by an operator, the one or more user commands comprising known sequences of pulls on the at least two pull cords on either or both of the at least two pull cords.

### BRIEF DESCRIPTION OF THE DRAWINGS

The above and other objects and features of the embodiments will become apparent and more readily appreciated from the following description of the embodiments with reference to the following figures. Different aspects of the embodiments are illustrated in reference figures of the drawings. It is intended that the embodiments and figures disclosed herein are to be considered to be illustrative rather than limiting. The components in the drawings are not necessarily drawn to scale, emphasis instead being placed upon clearly illustrating the principles of the aspects of the embodiments. In the drawings, like reference numerals designate corresponding parts throughout the several views.

FIG. 1 illustrates a battery powered roller shade wherein the primary source of energy are one or more replaceable battery cells located in the hembar according to aspects of the embodiments.

FIG. 2 illustrates an electrical block diagram of a shade control system that can be used to program, receive instructions, transmit messages, and operate the battery powered roller shade of FIG. 1 according to aspects of the embodiments.

### DETAILED DESCRIPTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims. The detailed description that follows is written from the point of view of a control systems company, so it is to be understood that generally the concepts discussed herein are applicable to various subsystems and not limited to only a particular controlled device or class of devices, such as roller shades.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” or “in an embodiment” in various places throughout the specification is not necessarily referring to the same embodiment. Further, the particular feature, structures, or characteristics may be combined in any suitable manner in one or more embodiments.

The different aspects of the embodiments described herein pertain to the context of systems, methods, and modes for installing and operating a battery operated roller shade with the battery stored in the hembar, but is not limited thereto, except as may be set forth expressly in the appended claims.

For over 40 years Creston Electronics Inc., has been the world's leading manufacturer of advanced control and automation systems, innovating technology to simplify and enhance modern lifestyles and businesses. Crestron designs, manufactures, and offers for sale integrated solutions to control audio, video, computer, and environmental systems. In addition, the devices and systems offered by Crestron streamlines technology, improving the quality of life for those that work and/or live in commercial buildings, universities, hotels, hospitals, and homes, among other locations. Accordingly, the systems, methods, and modes of the aspects of the embodiments described herein, can be manufactured by Crestron Electronics Inc., located in Rockleigh, N.J.

Provided below is a list of features, in numerical order, used throughout this specification:

| | |
|---|---|
| 100 | Battery Operated Roller Shade (Roller Shade) |
| 102 | Shade |
| 104 | Hembar |
| 106 | Conductive Path(s) |
| 108 | Roller Tube |
| 110 | Motor Housing |
| 112 | Pull Cord |
| 202 | Primary Power Source |
| 204 | Rechargeable Cell |
| 206 | Hembar User Interface |
| 208 | Low Power Indicator |
| 210 | Pull Cord User Interface (Cord Interface) |
| 212 | Drive Wheel |
| 214 | Brush Contacts |
| 216 | Low Power Radio |
| 218 | High Power Radio |
| 220 | Secondary Power Source |
| 222 | Electric Motor |
| 224 | Motor Controller (Controller) |
| 226 | Spring Assist |
| 228 | Drive Train |
| 230 | Rotary Position Encoder |
| 232 | Antenna |
| 234 | Low Noise Amplifier (LNA) |
| 236 | Remote Control Device (RCD) |
| 238 | Touch Actuator |
| 240 | Charging Jack |
| 242 | Inductive Coupling Loop |
| 244 | Charging Station |
| 246 | Window Sill |
| 248 | Wall-Wart Power Supply |
| 250 | Conventional Electrical Wall Outlet (Outlet) |

Provided below is a list of acronyms, in alphabetical order, used throughout this specification:

| | |
|---|---|
| GHz | Giga Hertz |
| IR | Infra-Red |
| LNA | Low Noise Amplifier |
| MHz | Mega Hertz |
| RCD | Remote Control Device |
| UHF | Ultra-High Frequency |
| W | Watt(s) |

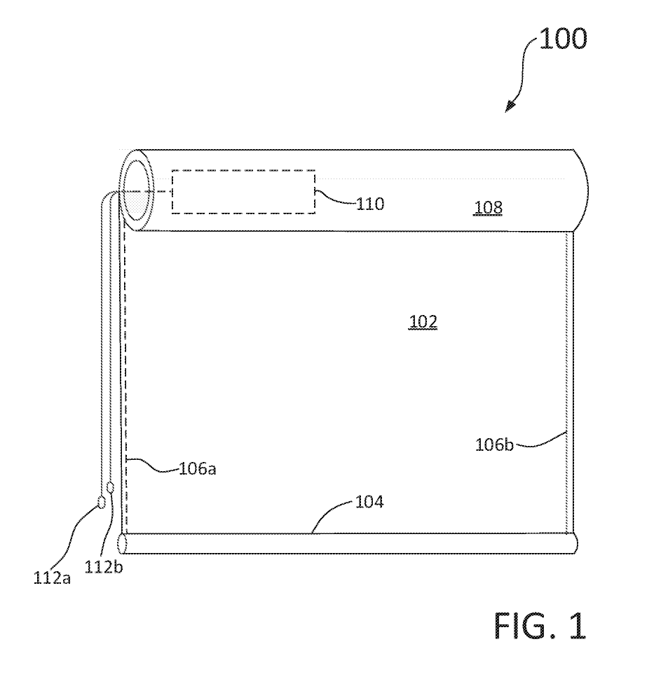

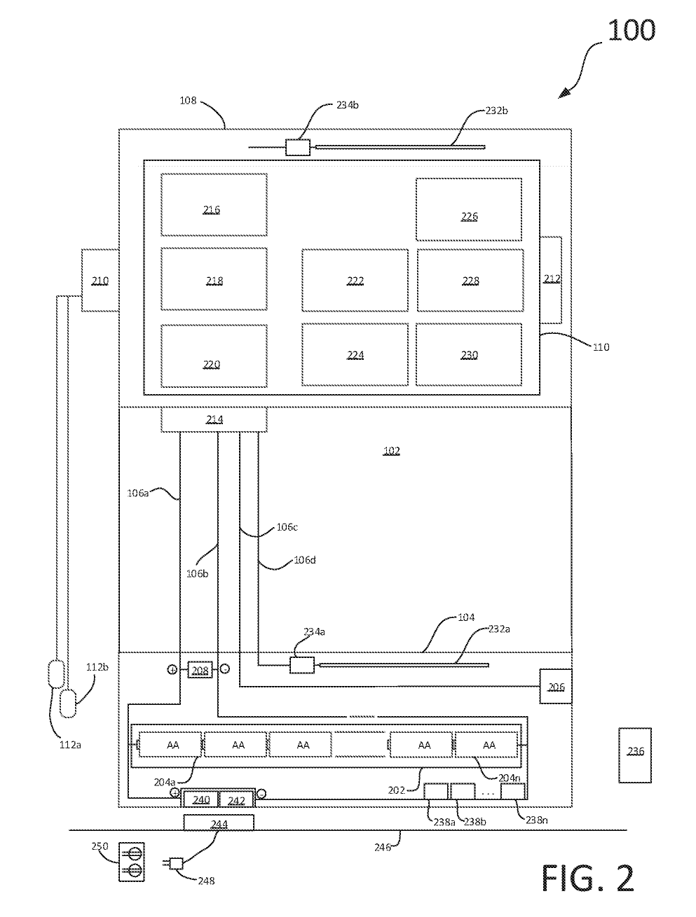

FIG. 1 illustrates a battery powered roller shade (roller shade) 100 wherein the primary source of energy are one or more replaceable battery cells located in hembar 104 according to aspects of the embodiments. and FIG. 2 illustrates an electrical block diagram of roller shade 100 that can be used to program, receive instructions, transmit messages, and operate the components of roller shade 100 of FIG. 1 according to aspects of the embodiments. Only certain interconnections have been shown in FIGS. 1 and 2 in fulfillment of the dual purposes of clarity and brevity; however, those of skill in the art can appreciate and understand the omitted electrical and mechanical interconnections of the devices shown in FIGS. 1 and 2.

According to aspects of the embodiments, roller shade 100 includes primary power source 202 that comprises one or more rechargeable cells 204a-n arranged, according to aspects of the embodiments, in either a series connection or a parallel connection, or combination thereof, and wherein the plurality of rechargeable cells 204a-n are housed within a hembar 104 of roller shade 100. A secondary energy storage cell (secondary power source 220) can also be housed in motor housing 110 within roller tube 108. Secondary power source 220 is designed to provide peak current required by electric motor 222 when it turns and primary power source 202 is designed to trickle charge secondary power source 220 by passing current through thin, electrically conductive paths 106a-d woven within shade 102. A third source of energy, such as a solar cell (not shown; and described in greater detail below), can also be provided to supplement the energy from the one or more aforementioned sources of power.

According to aspects of the embodiments, roller shade 100 comprises one or more of the following components, each of which is described in greater detail below: electric motor 222 and drive train 228; rotary position encoder 230; spring assist 226; drive wheel 212; roller tube 108; shade 102; motor controller 224; low power radio 216; high power radio 218; hembar 104; primary power source 202; secondary power source 220; solar cell; conductive path 106; hembar user interface 206; pull cords 112a,b; low power indicator 208, and charging interface (comprised of parts 240, 242, 244, 244, 250, described in greater detail below).

FIG. 1 illustrates several of the major components of roller shade 100 according to aspects of the embodiments. Roller shade 100 comprises electric motor 222 and drive train 228 can be provided and coupled to a combined assembly of a drive shaft and drive wheel 212. Drive train 228 can be geared to provide sufficient torque to lift shade 102 and hembar 104. drive assembly (drive train 228 and drive wheel 212) can also contain spring assist 226 to help offset the weight of shade 102 and hembar 104, thereby reducing the torque requirement on electric motor 222.

Rotary position encoder 230 can be coupled to the output drive shaft of drive train 228 and drive wheel 212. Rotary position encoder 230 provides position information to motor controller (controller) 224, allowing substantially accurate position and speed control. The encoder position can stored in non-volatile memory (not shown, though according to aspects of the embodiments, can be part of controller 224).

Roller tube 108 can be coupled to the drive shaft via drive wheel 212, and shade 102 can be coupled to roller tube 108 so that it can be windingly received.

Controller 224 can also be provided to regulate the speed of electric motor 222 and calculate position based on the output of rotary position encoder 230. Controller 224 can receive target position and one or more speed commands from either or both of low power radio 216 and high power radio 218. As those of skill in the art can appreciate, either or both of low power radio 216 and high power radio 218 can be a transceiver, or, alternatively, a separate transmitter and receiver pair.

Low power radio 216 can be provided for receiving a “wake-up” signal from a remotely located controller (remote control device (RCD)) 236 and can begin a process whereby high power radio 218 can be energized. RCD 236 can use any one or more of BlueTooth, WiFi, UHF, Infra-Red (IR), and other wireless transmission technologies to communicate to either or both of low power radio 216 and high power radio 218.

Use of low power radio 216 operating in the ultra-high frequency (UHF) band (300 MHz to 3 GHz, with a corresponding wavelength between 1 meter to 1 decimeter) can reduce the power consumption of roller shade 100, thus allowing the higher power consumption electronics to be used only when necessary according to aspects of the embodiments. Low power radio 216 can be housed in motor housing 110, or in hembar 104, among other locations. Mounting low power radio 216 and antenna 232a in hembar 104 can provide improved radio performance, as a larger antenna 232 can be developed and installed therein, and the location of the antenna can provide greater isolation from the effects of the roller tube and mounting brackets. In addition to antenna 232, low noise amplifier (LNA) 234a,b can be used to amplify the received signal before processing by either or both of low power radio 216 and high power radio 218. LNA 234a can be located in hembar 104 for use with antenna 232a, and LNA 234b can be located in motor housing 110 for use with antenna 232b.

High power radio 218 can be provided for receiving commands from a remotely located controller and transmitting information, such as positional information, among other types of information, back to the remotely located controller. High power radio 218 can be a high performance radio capable of operating in a Zigbee mesh network. As those of skill in the art can appreciate, either or both of low power radio 216 and high power radio 218 can both transmit and receive (transceiver).

Hembar 104 can be attached to a lower end of shade 102 providing means to keep the shade taught. Hembar 104 typically has one or more weights included therein, but in this instance, according to aspects of the embodiments, the one or more rechargeable cells 204 can also supplement the weights normally provided, or can be used in lieu thereof.

As described above, rechargeable cell 204 can be located within hembar 104 according to aspects of the embodiments. Locating rechargeable cells 204 in hembar 104 allows easy access for replacement. The total number of rechargeable cells 204 can vary based on the size of hembar 104, and the power requirements of roller shade 100. According to aspects of the embodiments, rechargeable cell 204 can be a standard AA size, and, alternatively, such rechargeable cell 204 can be a standard non-rechargeable type alkaline cell, or a rechargeable lithium ion type cell, among other types of rechargeable and non-rechargeable types of cells. Additional electronics can also be provided within hembar 104 to boost the voltage or maintain a fixed charging current, overcoming any variations in resistance of the conductive path. According to aspects of the embodiments, boosting the voltage is preferable to maintaining a fixed charging current in order to minimize resistive losses in the conductive path. Many boost topologies currently exist that provide for the aforementioned advantages. A buck regulator (not shown) can also be provided at motor housing 110 to reduce the voltage down to required level to charge one or more secondary cells located within secondary power source 220 according to aspects of the embodiments. As described above, conductive path 106 can be sewn into shade 102 to carry the current to electric motor 222 and the other electronic devices (shown as conductive paths 106a,b); typically, such conductive path 106 has a resistance of about 16 Ohms per foot. According to aspects of the embodiments, a typical installation can include a shade length of about 10 feet, providing a total resistance of about 320 Ohms. If the primary cell voltage is about 12V, and the required voltage at the secondary cell is about 9V, the current would be limited by the impedance of conductive path 106 to be less than about 10 mA, providing about 90 mW of power to the secondary cell, and dissipating about 30 mW of power in conductive paths 106a,b. Boosting the primary voltage to 36V reduces the required current to deliver the same power, thereby improving the overall efficiency of the electrical system.

Also shown in FIG. 2 is low power indicator 208, which can also optionally be located in hembar 104. Low power indicator 208 can be located in motor housing 110, and instead of a visual/aural indicator when located in hembar 104, when located in motor housing 110 it can be transmit a signal to controller 224 and/or low power radio/high power radio 216/218, for transmission back to the operator by either or both of the radios.

Secondary power source 220 can also be provided in roller shade 100, according to aspects of the embodiments. Secondary power source 220 can also be comprised of rechargeable cells (not shown), or a capacitor (also not shown). Secondary power source 220 can be located within motor housing 110 to provide current to electric motor 222 while it is turning. According to aspects of the embodiments, secondary power source 220 can be used to provide surge power during startup of electric motor 222, when the power demand is particular high. When electric motor 222 starts up, and even when it is running following start up, electric motor 222 can used a substantial amount of power, on the order of about 10 watts (W) or more, depending on size and weight of shade 102. As described above, the resistance of conductive path 106 connecting primary cells 204 to electric motor 222 and the other electronics located in motor housing 110 can generate a significant voltage drop, limiting the amount of power available.

As described above, one or more solar cells (not shown) can also be provided for supplementing power from primary power source 202 in order to extend the life of rechargeable cells located in either or both of primary power source 202 and secondary power source 220 according to aspects of the embodiments. The solar cell can also be built into hembar 104 and face out towards the window (away from the inner portion of a room) to collect energy from the sun. The solar cell can also face inwards into the room, thereby collecting energy from artificial light sources within the room. In addition, and according to further aspects of the embodiments, the solar cells can be made part of shade 102 with the appropriate physical interconnections.

One or more conductive paths 106a-d can be woven into shade 102 to electrically connect primary power source 202 to motor housing 110 to charge secondary primary source 220 while electric motor 222 is static. The one or more conductive paths 106a-d are generally thin, and can be discretely located so as not to be visible to the end user. According to aspects of the embodiments, conductive path 106a-d can be fabricated, by way of non-limiting example only, using conductive threads that are readily available and that can be sewn into the material shade 102 is made of, after it has been cut to size. Alternatively, conductive paths 106a-d can be made of different conductive materials. According to further aspects of the embodiments, conductive paths 106a-d can be made in the form of a conductive thread that can be taped to the back of shade 102. According to aspects of the embodiments, there can be two conductive paths 106 for primary power source 202: a first conductive path 106a to provide the power and a second conductive path 106b to provide a return. Additionally, conductive path 106c can also provide means for signaling between electronics, such as hembar user interface 206, located within hembar 104 and the electronics within motor housing 110 according to aspects of the embodiments. According to still further aspects of the embodiments, antenna 232a and LNA 234a can be located in hembar 104 and provide amplified received radio signals to the electronics located in housing 110 by conductive path 106d. Each of signals/voltages carried conductive paths 106a-d are connectable to the electronics located within motor housing 110 through the use of brush contacts 214, the use of which are known to those of skill in the art, and thus a description thereof has been omitted in fulfillment of the dual purposes of clarity and brevity.

One or more user interfaces can also be provided to perform setup functions such as setting of limits, as well as one or more user controls. Such user controls can include, but are not limited to, opening or closing the shade. According to further aspects of the embodiments, there are numerous embodiments that can be used as a means for a user interface, such as pull strings (pull cords 112a,b), buttons, and touch-sensitive actuators (touch actuators 238a-n), each of which will be discussed in turn. As those of skill in the art can appreciate, however, the discussion of such user interfaces should not be taking in a limiting manner.

As shown in FIG. 2, hembar user interface 206, which can use conductive path 106c as a means for signaling between itself and the electronics within motor housing 110 according to aspects of the embodiments. Hembar user interface 206 provides a means for a user to control roller shade 100 according to aspects of the embodiments, and receive feedback information from different components of roller shade 100, such as height, among other information. According to further aspects of the embodiments, hembar user interface 206 can signal and receive information to and from the electronics located in motor housing 110 by an alternating voltage that is transposed onto the direct voltage of conductive path 106a, thereby eliminating the need for a separate conductive path 106 c.

As further shown in FIG. 2, pull cords 112a,b can be attached to pull cord user interface (cord interface) 210 located on roller tube 108 to allow control of roller shade 100 in similar fashion as a conventional manual shade. Pull cords 112a,b can be attached to electronic switches that are part of cord interface 210 connected to controller 224. According to aspects of the embodiments, and not to be taken in a limiting manner, there are several modes of operation, such as the one that follows, that can control roller shade 100. A tug on first pull cord 112a can trigger roller shade 100 to move to a full open position. A tug on second pull cord 112b can trigger roller shade 100 to move to a full closed position. A subsequent tug on the first (or second) pull cord 112a,b, while shade 102 is moving, can trigger shade 102 to stop moving. Pulling and holding either (or both) pull cord(s) 112a,b can trigger roller shade 100 to raise or lower, while the respective pull cord 112 is held, and stop when the respective pull cord 112 is released. Such functions with respect to the cords pull 112a,b can be interchangeable as well.

According to further aspects of the embodiments, additional functions can also be implemented. For example, pulling and holding both pull cords 112a,b for a period of time, such as 5 seconds (by way of non-limiting example only), can trigger roller shade 100 to enter a “limit setting” mode. Shade 102 of roller shade 100 can then be moved to either of an upper or lower limit, and the limit can be saved by pulling and holding both pull cords 112a,b. The process can be repeated for both upper and lower limits.

According to further aspects of the embodiments, one or more buttons can be used on the hembar for functions such as opening, closing, or setting limits. Such buttons can be embodied in the form of hembar user interface 206 according to aspects of the embodiments. Control signals indicating the state of the buttons can be transmitted to controller 224 by modulating the power connection, or by transmitting the information on conductive path 106c attached or woven into shade 102.

According to still further aspects of the embodiments, touch sensitive actuators 238a-n can also be incorporated into hembar 104 that provide functional control such as allowing shade 102 to be opened or closed by applying an upward or downward force on hembar 104.

Charging jack 240, or inductive coupling loop 242 can also be provided within hembar 104 to provide primary or secondary battery recharging current. When shade 102 is fully lowered, charging jack 240 and/or inductive coupling loop 242 couples to charging station 244 positioned on window sill 246. Charging station 244 can be powered from a conventional power source, such as a “wall-wart” power supply, or located within window sill 246 and permanently connected to local power, via wall-wart power supply 248, and outlet 250. Shade 102 can be configured to automatically lower when cells 204 (and others in secondary power source 220) are at a critically low state allowing recharging to occur.

According to aspects of the embodiments, a battery powered motorized window treatment can be provided, comprising: a motor drive unit housed within a roller tube; a fabric (shade) coupled to the roller tube; a hembar attached to the lower end of the shade adapted to house replaceable battery cells; a secondary energy storage device in the form of a rechargeable battery or capacitor located within the motor housing; an electrical connection between the hembar and motor drive unit; one or more radio receivers adapted to receive control signals from a controller; a solar cell on back of hembar to supplement charge from primary battery cells; and a “lower-battery” indication can also be provided on the hembar.

According to still further aspects of the embodiments, a motorized window treatment is provided, comprising: a motor drive unit housed within a roller tube; a shade coupled to the roller tube; a hembar attached to the lower end of the shade adapted to provide a user interface; and wherein the user interface comprises one or more sets of tactile buttons, touch sensitive elements, indicator LEDs, among other types of indicators; and an electrical connection between the hembar and motor drive unit.

According to still further aspects of the embodiments, a motorized window treatment is provided, comprising: a motor drive unit housed within a roller tube; a shade coupled to the roller tube; and one or more pull cords coupled to electronic switches within the motor drive unit allowing the roller shade to be operated by pulling on the one or more pull cords.

According to still further aspects of the embodiments, a motorized window treatment is provided, comprising: a motor drive unit housed within a roller tube; a shade coupled to the roller tube; and a hembar attached to the lower end of the shade adapted to house a radio receiver and antenna.

According to still further aspects of the embodiments, a motorized window treatment is provided, comprising: a motor drive unit housed within a roller tube; a shade coupled to the roller tube; a hembar attached to the lower end of the shade adapted to couple the motor and one or more rechargeable batteries to a power charging station; and a motor controller programmed to lower the shade automatically when a low battery level is detected.

Reference may have been made in regard to FIGS. 1 and 2 to several dimensions, and units of measure, including one or more of radii, angles, height, voltage, current, among others. Those of skill in the art can appreciate that although examples of dimensions and units may have been provided, these should not be taken in a limiting manner; that is, the aspects of the embodiments are not to be construed as defined or limited by the specific example of the dimensions/measurements shown and discussed, but instead are provided merely for illustrating an example of what a device that incorporates the aspects of the embodiments could, in a non-limiting manner, look like, or be characterized by. Furthermore, as those of skill in the art can appreciate, since the aspects of the embodiments are directed towards a physical object, with dimensional characteristics, all of the parts will have various dimensions/measurements, some of which are not shown in fulfillment of the dual purposes of clarity and brevity. According to still further aspects of the embodiments, some of these objects will have dimensional characteristics and/or units of measurement that lend themselves to aesthetic aspects; in fulfillment of the dual purposes of clarity and brevity, dimensions in this regard have also been omitted. Therefore, as the aspects of the embodiments are directed towards a battery operated roller shade, it is to be understood that the dimensions/units of measurement of the different objects, some dimensions/units of measurement shown/discussed, some dimensions/units of measurement not shown/discussed, will be understood by those of skill in the art.

The embodiments described herein provide systems, methods, and modes for a battery operated roller shade 100. It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details.

Although the features and elements of aspects of the embodiments are described being in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

All United States patents and applications, foreign patents, and publications discussed above are hereby incorporated herein by reference in their entireties.

### INDUSTRIAL APPLICABILITY

To solve the aforementioned problems, the aspects of the embodiments are directed towards systems, methods, and modes of a battery operated roller shade.

### ALTERNATE EMBODIMENTS

Alternate embodiments may be devised without departing from the spirit or the scope of the different aspects of the embodiments.

What is claimed is:

1. A battery powered roller shade (100), comprising:
a shade (102) made of suitable shade fabric or other material;
a roller tube (108), around which can be rolled the shade,
the roller tube configured to contain a motor housing (110), drive wheel (212), and user interface switches (210),
the motor housing including an electric motor (222) configured to drive the tube to wind the shade onto the roller tube, and to unwind the shade off of the roller tube;
a hembar (104) located at a lowermost position of the shade and configured to maintain tautness in the shade, the hembar configured to house a primary power source (202) that powers the motor; and
at least two electrical conductors (106) interwoven in the shade to provide current to the motor by the primary power source.

2. The battery powered roller shade according to claim 1, further comprising:
a secondary power source located in the motor housing, the secondary power source configured to provide peak power when needed by the motor to wind or unwind the shade.

3. The battery powered roller shade according to claim 2, further comprising:
a recharging apparatus (240, 242, 244, 246, 248, 250) configured to provide recharging current.

4. The battery powered roller shade according to claim 3, wherein
the primary power source and the secondary power source comprise one or more rechargeable batteries (204) each, and wherein the recharging apparatus provides recharging current to the primary power source, and the primary power source provides recharging current to the secondary power source.

5. The battery powered roller shade according to claim 3, wherein the recharging apparatus comprises:
a solar powered recharging apparatus configured to be incorporated into the shade material.

6. The battery powered roller shade according to claim 3, wherein the recharging apparatus comprises:
one or more of a solar cell, charging jack, and inductive loop configured to receive electrical alternating voltage and current provided by the building within which the roller shade is located, and convert the alternating voltage and current to a direct voltage and current that can be used to recharge either or both of the primary and secondary power sources.

7. The battery powered roller shade according to claim 1, further comprising:
a low power consuming transceiver configured to receive remotely transmitted commands for operating the shade, and to provide the commands to the motor, and wherein the transceiver is further configured to transmit one or more of roller shade position information, and other status information.

8. The battery powered roller shade according to claim 7, wherein
the low power consuming transceiver is configured to be housed in the roller tube.

9. The battery powered roller shade according to claim 7, wherein
the low power consuming transceiver configured to be housed in the hembar.

10. The battery powered roller shade according to claim 7, further comprising:
an antenna for the low power consuming transceiver configured to be located in the roller tube.

11. The battery powered roller shade according to claim 7, further comprising:
an antenna for the low power consuming transceiver configured to be located in the hembar.

12. The battery powered roller shade according to claim 1, further comprising:
a high power consuming transceiver (218) configured to receive remotely transmitted commands for operating the shade, and to provide the commands to the motor, and wherein the transceiver is further configured to transmit one or more of roller shade position information and other status information.

13. The battery powered roller shade according to claim 12, wherein
the high power consuming transceiver is configured to be housed in the roller tube.

14. The battery powered roller shade according to claim 12, wherein
the high power consuming transceiver configured to be housed in the hembar.

15. The battery powered roller shade according to claim 12, further comprising:
an antenna for the high power consuming transceiver configured to be located in the roller tube.

16. The battery powered roller shade according to claim 12, further comprising:
an antenna for the high power consuming transceiver configured to be located in the hembar.

17. The battery powered roller shade according to claim 1, further comprising:
a user interface apparatus configured to receive one or more user commands through operation of at least two pull cords operable by an operator, the one or more user commands comprising known sequences of pulls on the at least two pull cords on either or both of the at least two pull cords.
